(19) United States
(12) Patent Application Publication
(10) Pub. No.: US 2006/0092285 A1
(43) Pub. Date: May 4, 2006

(54) Optical image stabilizer for camera lens assembly

(75) Inventor: Doo-Sik Shin, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/105,084

(22) Filed: Apr. 13, 2005

(30) Foreign Application Priority Data
Nov. 3, 2004 (KR) 2004-89033

(51) Int. Cl. H04N 5/228

(52) U.S. Cl. 348/208.7

(57) ABSTRACT

An optical image stabilizer for a camera lens assembly includes: a board that has an image sensor on a top surface thereof and disposed movably in the housing, the board and the housing being spaced apart from each other; at least one magnetic body disposed between the board and the housing, the magnetic body providing a magnetic force acting in a direction along which the board is closely contacted to inner surface of the housing; at least three balls interposed between the board and the inner surface of the housing for maintaining the board in such a state that it is spaced apart from the housing; and a driving unit for correcting the position of the image sensor by moving the board according to the degrees of trembling of user's hands. In the optical image stabilizer for a camera lens assembly, the driving unit for driving the board, on which an image sensor is mounted, is present substantially on the same surface as the board itself. As a result, the optical image stabilizer can downsize a product equipped with a camera lens assembly and can improve the reliability of the product.

### CLAIM OF PRIORITY

This application claims priority to an application entitled “Optical Image Stabilizer for Camera Lens Assembly,” filed in the Korean Intellectual Property Office on Nov. 3, 2004 and assigned Serial No. 2004-89033, the contents of which are hereby incorporated by reference.

### BACKGROUND OF THE INVENTION

1. Field of the Invention

The present invention relates to a camera device, and more particularly to an optical image stabilizer for a camera lens assembly.

2. Description of the Related Art

As is generally known in the art, a CCD (Charge Coupled Device) sensor and a CMOS (Complementary Metal Oxide Semiconductor) sensor are used for photographing dynamic and static images. Particularly, CCD sensors provide excellent characteristics compared to CMOS sensors in terms of image quality. However, CCD sensors have disadvantages of high power consumption and complicated structures. As such, CMOS image sensors are more popular in the market, especially in the portable digital device fields.

When photographing moving images using image sensors, unstable images are frequently photographed due to the trembling of cameras resulting from external causes, such as the user's trembling hands and mounting of cameras on vehicles. To address this problem, optical image stabilizers with a movement detector and a movement compensator have been incorporated in the cameras.

FIG. 1 shows a part of the cameral lens assembly including an optical image stabilizer 100 to control the unstable images using an image sensor 101 according to the prior art.

As shown in FIG. 1, the optical image stabilizer 100 used in the conventional camera lens assembly is provided with stages 102, 103 for driving the image sensor 101 in one direction X and another direction Y, on the front surface and the rear surface of the image sensor 101, respectively, so that the input position of the image sensor 101 can be controlled.

The stages 102, 103 include a fixable stage 102 and a movable stage 103.

The fixable stage 102 is equipped with a pair of first guides 121 facing to each other at both sides thereof, both guides 121 extending in the first direction X in parallel to each other. The movable stage 103 is coupled to the first guides 121 in such a manner that it is capable of moving linearly on the first guides 121, thereby reciprocating linearly in the first direction X.

The movable stage 103 is equipped with a pair of second guides 131 facing to each other at both sides thereof, both guides 131 extending in the second direction Y in parallel to each other. The second direction Y is perpendicular to the first direction X. The image sensor 101 is coupled to the second guides 131 in such a manner that it is capable of moving linearly on the second guides 131, thereby reciprocating linearly in the second direction Y.

Accordingly, as the movable stage 103 moves in the first direction X, the image sensor 101 also moves in the first direction X, while the image sensor 101 moves in the second direction Y on the movable stage 103 at the same time.

As stated above, the optical image stabilizer 100 of the conventional camera lens assembly has a structure including a pair of stages 102, 103 disposed at both surfaces of the image sensor 101 so that the image sensor 101 can be moved in two directions corresponding the trembling of user's hands. However, due to two stages on both surfaces of an image sensor, the conventional image stabilizer hinders the camera lens assembly from being downsized. Therefore, it is difficult to mount a camera lens assembly on a product that requires a space for mounting an additional component, such as a portable terminal.

### SUMMARY OF THE INVENTION

Accordingly, the present invention has been made to solve the above-mentioned problems occurring in the prior art and provides additional advantages, by providing an optical image stabilizer for a camera lens assembly, which facilitates the downsizing of a product equipped with a camera lens assembly.

One aspect of the present invention is to provide an optical image stabilizer for a camera lens assembly, which ensures solidity and reliability of a product equipped with a camera lens assembly, while facilitating downsizing of the same product.

According to another aspect of the present invention, there is provided an optical image stabilizer for a camera lens assembly, which includes: a housing; a board that has an image sensor on the top surface thereof and disposed movably in the housing, the board and the housing being spaced apart from each other; at least one magnetic body disposed between the board and the housing, the magnetic body providing a magnetic force acting in a direction along which the board is closely contacted to the inner surface of the housing; at least three balls interposed between the board and the inner surface of the housing for maintaining the board in such a state that it is spaced apart from the housing; and a driving unit for correcting the position of the image sensor by moving the board according to trembling level of user's hands.

According to another aspect of the present invention, there is provided an optical image stabilizer for a camera lens assembly, which includes: a frame housing; a first frame coupled to the frame housing in such a manner that the first frame can move horizontally along one direction in the frame housing; a second frame coupled to the first frame in such a manner that the second frame can move horizontally along another direction perpendicular to the first direction on the first frame; and an image sensor package contained in the second frame.

### BRIEF DESCRIPTION OF THE DRAWINGS

The above features and advantages of the present invention will be more apparent from the following detailed description taken in conjunction with the accompanying drawings, in which:

FIG. 1 is a perspective view of a camera lens assembly according to the prior art;

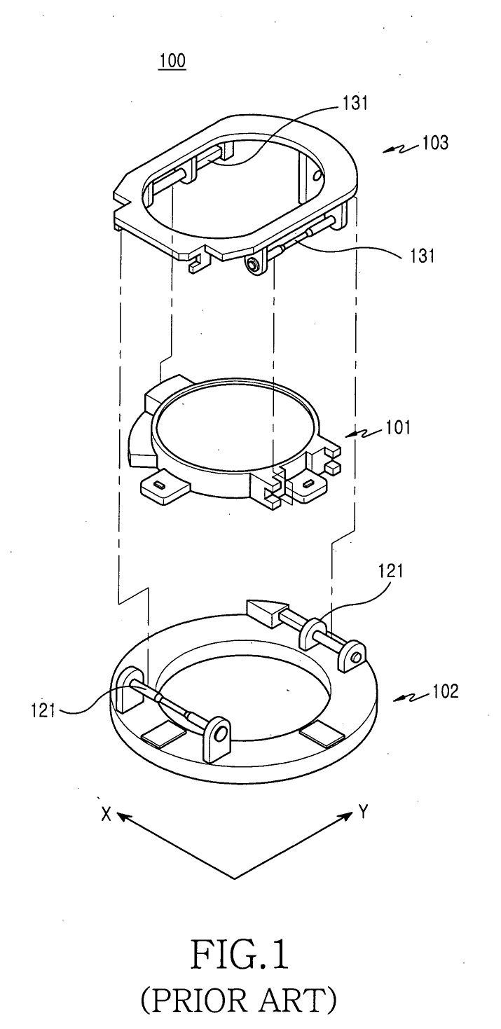

FIG. 2 is a perspective view of a camera lens assembly equipped with an optical image stabilizer according to an embodiment of the present invention;

FIG. 3 is an exploded perspective view of the optical image stabilizer included in the camera lens assembly shown in FIG. 2;

FIG. 4 is a perspective view of the optical image stabilizer shown in FIG. 3;

FIG. 5 is a perspective view of the bottom surface of the board included in the optical image stabilizer shown in FIG. 3;

FIG. 6 is a lateral sectional view of the optical image stabilizer shown in FIG. 3;

FIG. 7 is a front view of the optical image stabilizer shown in FIG. 3;

FIG. 8 is a schematic view of the operations of the optical image stabilizer shown in FIG. 3;

FIG. 9 is an exploded perspective view of a camera lens assembly equipped with an optical image stabilizer according to another embodiment of the present invention;

FIG. 10 is a perspective view of the optical image stabilizer shown in FIG. 9;

FIG. 11 is a lateral sectional view of the first frame, the second frame and the image sensor package of the optical image stabilizer shown in FIG. 10, after assemblage;

FIG. 12 is a perspective view of the frame housing of the optical image stabilizer shown in FIG. 9;

FIG. 13 is an exploded perspective of the bottom surface of the frame housing shown in FIG. 12;

FIG. 14 is a perspective view of the first frame of the optical image stabilizer shown in FIG. 9; and

FIG. 15 is a bottom perspective view of the first frame of the optical image stabilizer shown in FIG. 14.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

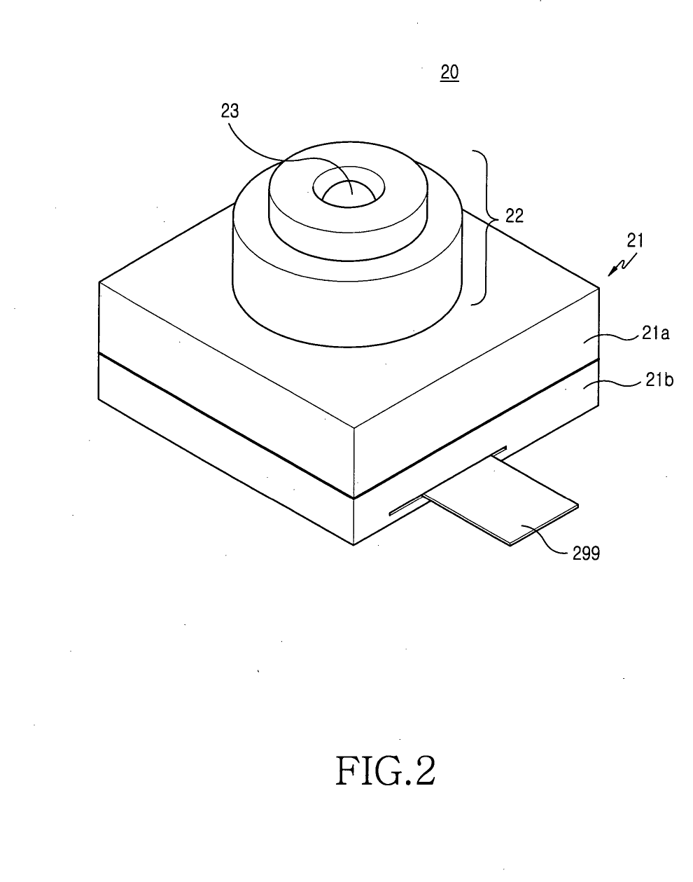

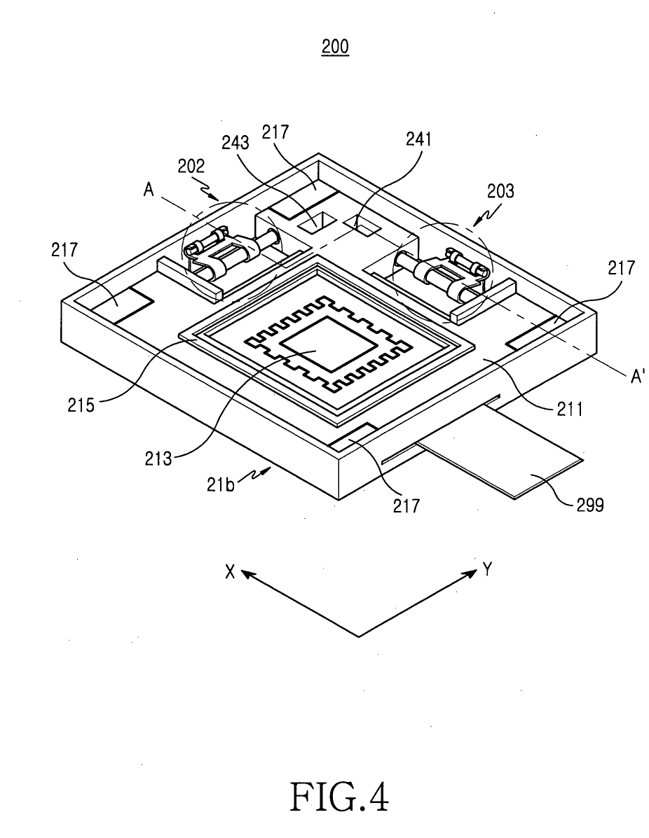

Referring to FIGS. 2 to 4, the optical image stabilizer 200 of the camera lens assembly 20 according to the present invention is disposed in a housing 21, more particularly in a lower housing 21b of the camera lens assembly 20. In operation, the optical image stabilizer 200 corrects the position of an image sensor 213 according to the trembling of user's hands to perform image stabilization.

The camera lens assembly 20 has a housing 21 including an upper housing 21a and a lower housing 21b, and an optical tube 22 in which at least one lens (not shown) is contained. The optical tube 22 extends from the upper housing 21a and has an exposure window 23 on the terminal surface thereof. The optical image stabilizer 200 including the image sensor 213, etc., is contained in the housing 21.

The optical image stabilizer 200 of the camera lens assembly 20 is disposed in the lower housing 21b, and includes a board 211, image sensor 213, magnetic bodies 217 and driving units 202, 203.

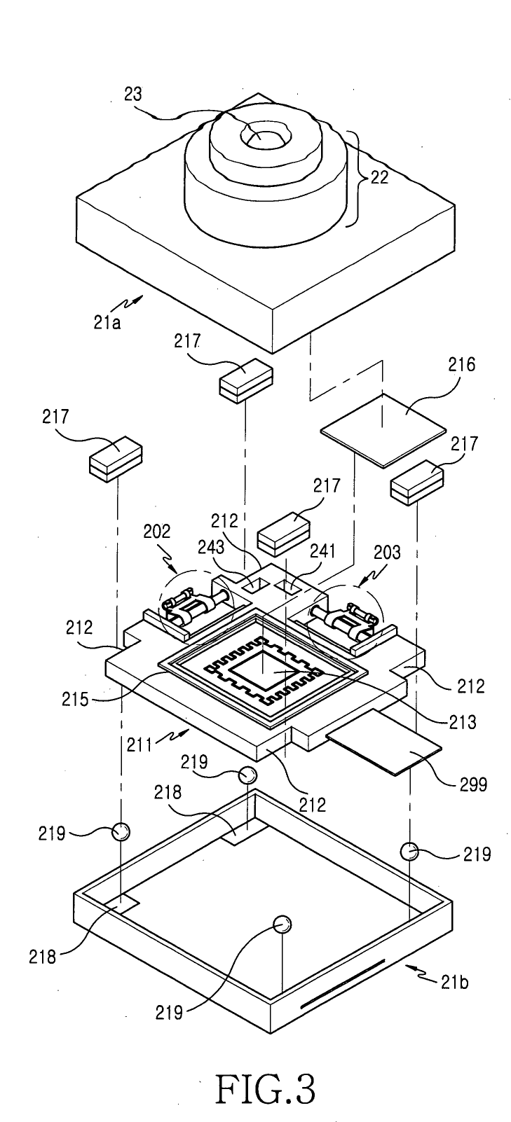

The board 211 faces to the inner surface of the lower housing 21b, while being spaced apart therefrom. The board 211 is formed in the shape of a flat panel and provided with four magnetic bodies 217 each disposed on each corner of the board 211. Iron pieces 218 are attached in the inner surface of the lower housing 21b at each position facing to each magnetic body 217. The magnetic force of the magnetic bodies 217 acts in the direction along which the board 211 is closely contacted to the lower housing 21b. Further, in order to maintain the board 211 in such a state that it is spaced apart from the inner surface of the lower housing 21b, at least three balls 219 are interposed between the board 211 and the lower housing 21b. In the embodiment illustrated in FIG. 3, four balls 219 are disposed at predetermined intervals.

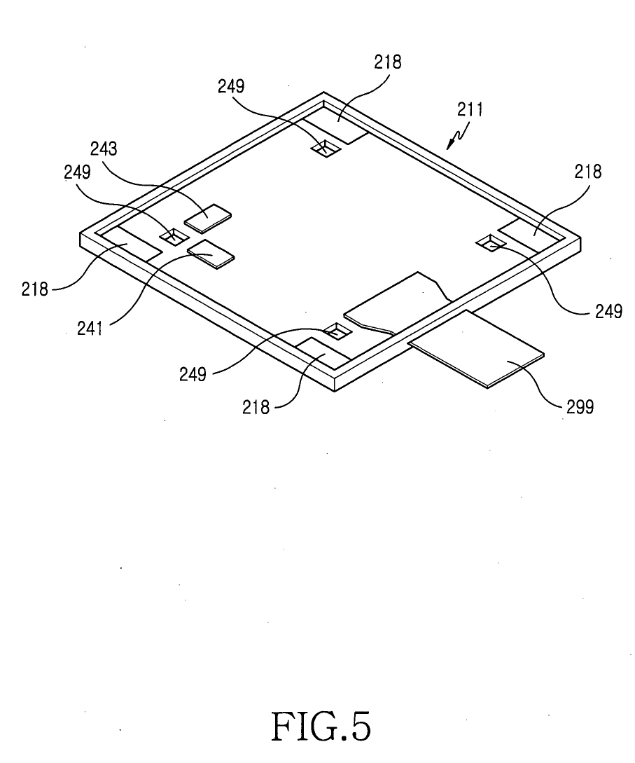

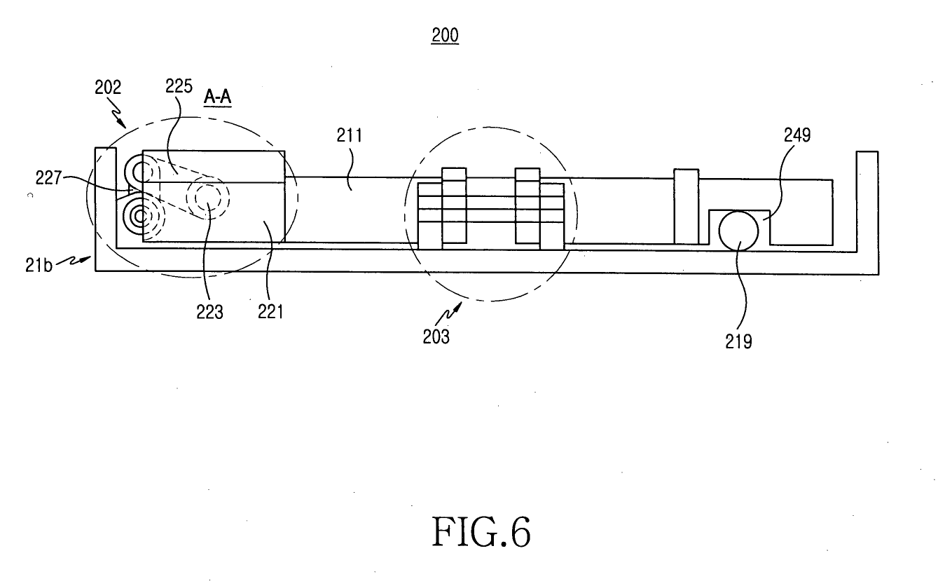

Referring to FIGS. 5 and 6, the bottom surface of the board 211 has receipt holes 249 so as to prevent the balls 219 from moving excessively between the board 211 and the lower housing 21b, while the balls 219 cause the board 211 to be spaced apart from the lower housing 21b. The depth of each receipt hole 249 is less than the diameter of each ball 219. Therefore, the balls 219 permit the board 211 to be spaced apart from the inner surface of the lower housing 21b. The board 211 can move in the lower housing 21b by the magnetic force of the magnetic bodies 217 and the balls 219, while maintaining the board 211 in such a state that it is spaced apart from the inner surface of the lower housing 21b.

Meanwhile, it is sufficient for the magnetic bodies 217 to provide a magnetic force acting only in the direction along which the board 211 is closely contacted to the lower housing 21b. Therefore, it is not necessary to mount the magnetic bodies at all corners of the board 211. Further, the number of the magnetic bodies mounted on the board 211 may be varied depending on the strength of magnetic force and the position of a particular magnetic body.

The image sensor 213 may be mounted directly on the board 211. Otherwise, the image sensor 213 may be disposed on an image sensor package 215 to form a module and then the module is mounted on the board 211. The image sensor 213 is the device transforming image information inputted through the exposure window 23 into electric signals and may be a CCD or CMOS sensor.

The image sensor 213 is coupled to the main circuit devices of a camera or portable terminal through a flexible printed circuit 299 extending from the board 211.

An IR cut-off filter 216 may be disposed between the exposure window 23 and the image sensor 213. The IR cut-off filter 216 interrupts the IR incident light inputted through the exposure window 23, and thus improves the image quality detected from the image sensor 213.

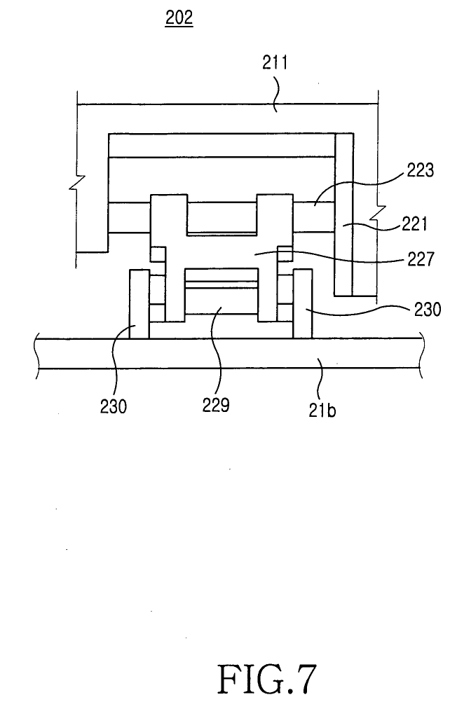

The driving units 202, 203 correct the position of the image sensor 213 by moving the board 211 according the trembling degree of user's hands. Referring to FIGS. 6 and 7, the driving units 202, 203 include a first driving unit 202 for moving the board 211 in one direction X and a second driving unit 203 for moving the board 211 in another direction Y The first and the second driving units 202, 203 have the same structure and different only in the moving direction. The first direction X refers to the direction extending in parallel with one surface of the board 211, and the second direction Y refers to the direction perpendicular to the first direction X as well as extending in parallel with one surface of the board 211.

Each of the first and the second driving units 202, 203 includes a driving element 221, a first and a second supports 223, 229, and a first and a second links 225, 227. As mentioned above, the first and the second driving units 202, 203 have the same structure. Therefore, reference will now be made in detail only to the structure and operation of the first driving unit 202 to void redundancy.

The driving element 221 vibrates according to the trembling degree of user's hands, and some exemplary device may include an ultrasonic motor, piezoelectric element, step motor, etc. The driving element 221 is attached to the board 211 to generate driving power for moving the board 211. In other words, when the driving element 221 of the first driving unit 202 operates, the board 211 moves in the first direction X. Similarly, when the driving element of the second driving unit 203 operates, the board 211 moves in the second direction Y.

The first support 223 is disposed in such a manner that it can move linearly on the board 211 in the direction horizontal to the board 211 according to the vibration of the driving element 221. The first support 223 extends from the driving element 221 in the first direction X. In other words, the board 211 and the first support 223 reciprocate relative to each other as well as linearly along the first direction X, the first support 223 guiding the linear reciprocation of the board 211.

The second support 229 is fixed on the lower housing 21b. A pair of supporting ribs 230 facing to each other as well as extending in the inner surface of the lower housing 21b, support both ends of the second support 229.

The first link 225 is coupled rotatably to the first support 223 at one end thereof and remaining end of the first link 225 is coupled rotatably to one end of the second link 227, while remaining end of the second link 227 is rotatably coupled to the second support 229.

As the first link 225 and the second link 227 couple the first support 223 with the second support 229, the board 211 can move in the direction perpendicular to the first direction X. Thus, the board 211 can move horizontally in the second direction Y. The first and the second links 225, 227 of the first driving unit 202 facilitate the horizontal movement of the board 211 in the second direction Y.

Now, motions of the board 211 according to the motion of the driving units 202, 203 will be explained in detail.

First, when the driving element 221 of the first driving unit 202 vibrates, the board 211 moves in the first direction X. Particularly, when the driving element 221 of the first driving unit 202 vibrates, the board 211 moves relative to the first support 223 as well as horizontally along the first direction X. More particularly, the first support 223 of the first driving unit 202 guides the horizontal movement of the board 211 in the first direction X. Meanwhile, the first and the second links 225, 227 of the second driving unit 203 rotate so as to come close to each other or to be away from each other according to the horizontal movement of the board 211 in the first direction X, thereby facilitating the horizontal movement of the board 211 in the first direction X.

Similarly, when the driving element 221 of the second driving unit 203 vibrates, the board 211 moves in the second direction Y according to the occurrence of linear reciprocation of the board 211 relative to the first support 223 of the second driving unit 203. Particularly, rotation of the first and the second links 225, 227 of the first driving unit 202 facilitate the horizontal movement of the board 211 in the second direction Y.

Meanwhile, the optical image stabilizer 200 further includes units for detecting a relative change in position of the board 211.

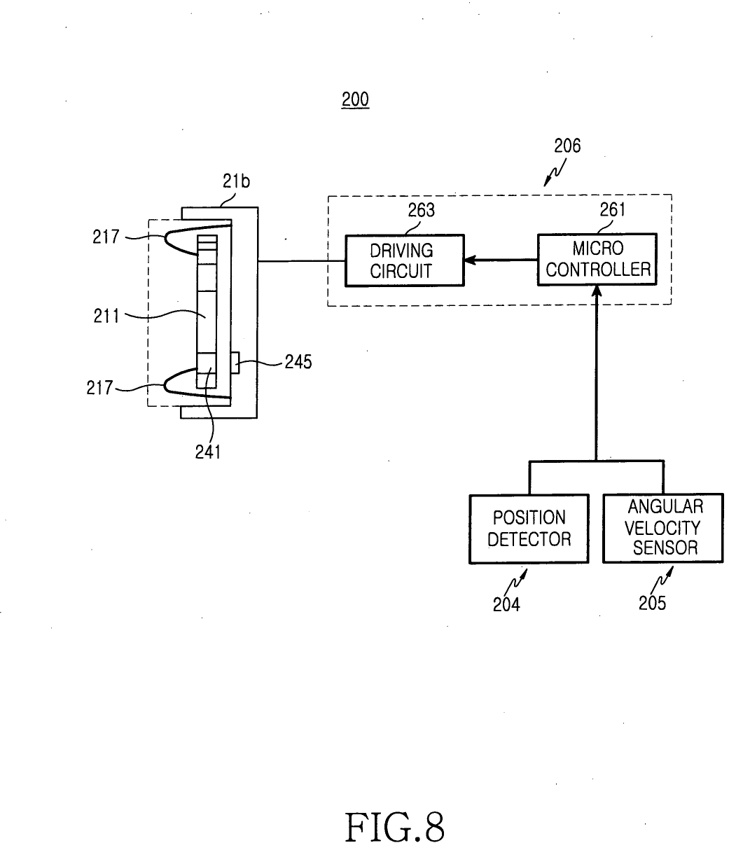

Referring to FIGS. 5 and 8, the optical image stabilizer 200 includes an angular velocity sensor 205 for detecting the trembling of user's hands, and a position detector 204 for detecting a relative change in position of the board 211. The angular velocity sensor 205 is disposed in the housing 21 or a camera body to detect the trembling of user's hands.

The position detector 204 including light emitting diodes 241, 243 and a photo diode 245 is disposed on the board 211 and on the lower housing 21b to detect a relative change in the position of the board 211. A pair of light emitting diodes 241, 243 is attached on the bottom surface of the board 211 so as to be faced to the inner surface of the lower housing 21b. The photodiode 245 is attached on the inner surface of the lower housing 21b in a position corresponding to the light emitting diodes 241, 243. Particularly, the light emitted from the light emitting diodes 241, 243 can be detected by the photo diode 245. More particularly, when the board 211 moves horizontally along the first direction X or the second direction Y it is possible to detect a relative change in the position of the board 211 according to the amount of light detected by the photo diode 245.

The data including a degree of trembling detected from the angular velocity sensor 205 and the position detector 204 and a relative change in position of the board 211 are supplied to a controller 206, then used in generating signals for operating the driving units 202, 203. Particularly, once the data detected from the angular velocity sensor 205 and the position detector 204 are supplied to a micro controller 261, the micro controller 206 calculates how much the board 211 should be moved based on the data detected from the angular velocity sensor 205 and the position detector 204, and also supplies the calculated value to a driving circuit 263 for driving the driving units 202, 203 so that the driving units 202, 203 can be operated.

Hereinafter, an optical image stabilizer according to another embodiment of the present invention will be explained in detail.

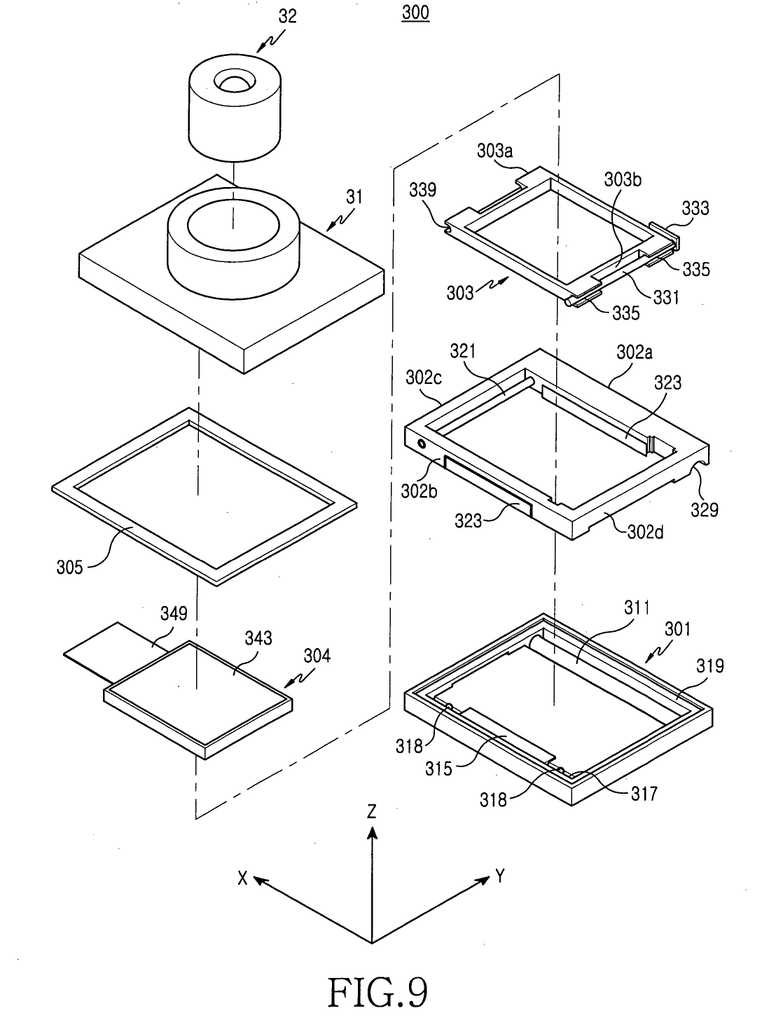

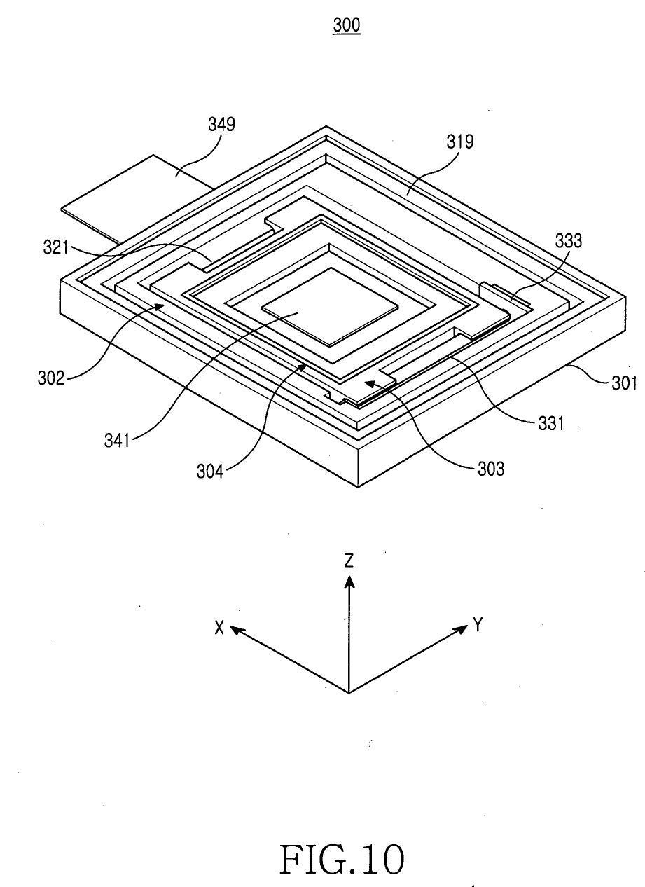

Referring to FIGS. 9 to 15, the optical image stabilizer according to another embodiment of the present invention includes a frame housing 301, a first frame 302, a second frame 303 and an image sensor package 304, the frame housing 301 being coupled to a housing 31 containing a lens assembly 32 to form a camera lens assembly 300.

The first frame 302 is disposed movably along one direction X in the frame housing 301. The second frame 303 is disposed movably along another direction Y on the first frame 302. The second direction Y is perpendicular to the first direction X and is present on a plane parallel to one surface of the frame housing 301, the first direction X being present on the same plane. Particularly, the image sensor package 304 is contained in the second frame 303, which in turn is contained in the first frame 302, which in turn is contained in the frame housing 301. Each of the first and the second frames 302, 303 and the image sensor package 304 is disposed within the range of thickness of the frame housing 301.

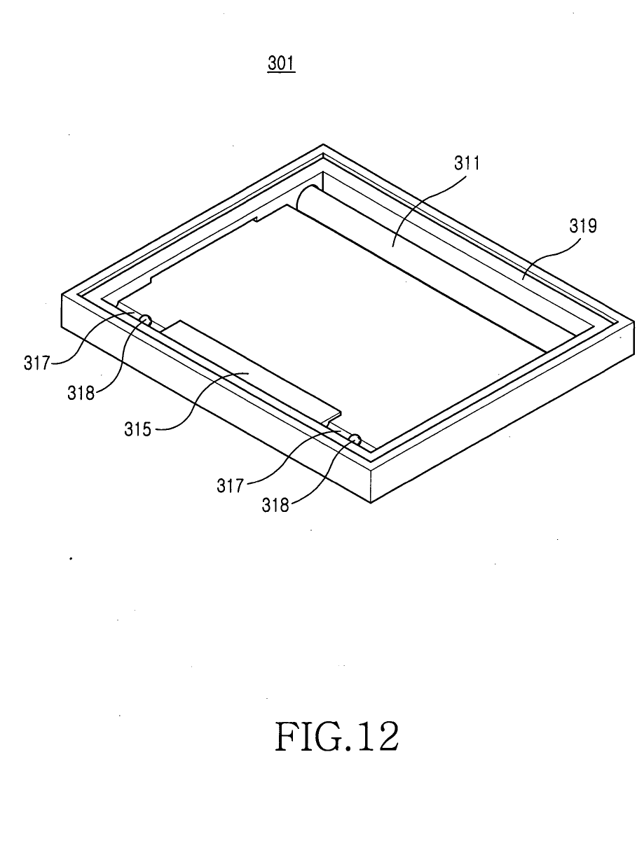

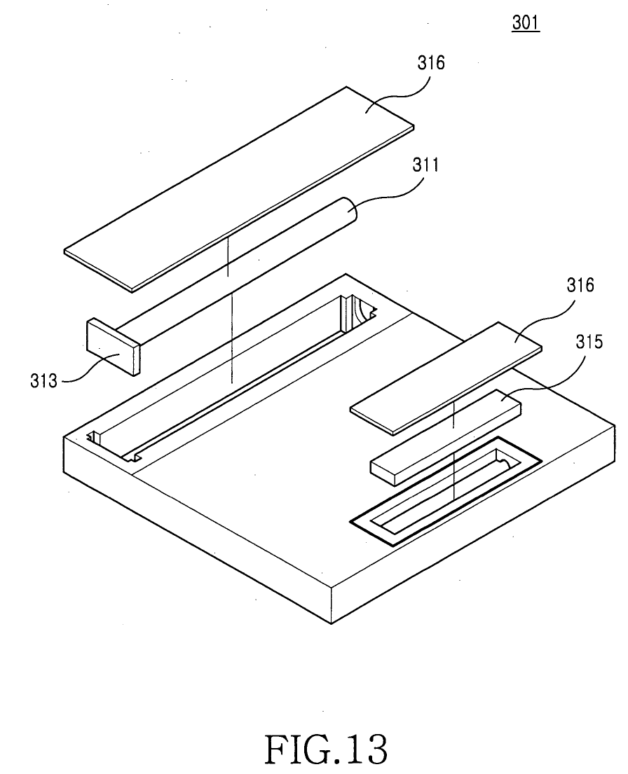

The frame housing 301 receives the first frame 302, the second frame 303 and the image sensor package 304. As shown in FIGS. 12 and 13, the frame housing 301 is depressed at one surface thereof and has a lodging surface 319 along the edges thereof. Additionally, a first piezoelectric element shaft 311 extending in the first direction X is coupled at one side of the inner part of the frame housing 301.

The first piezoelectric element shaft 311 is fixed to a first lateral end 302a of the first frame 302. One end of the first piezoelectric element shaft 311 is slidably coupled to the frame housing 301. A first piezoelectric element 313 is fixed at the other end of the first piezoelectric element shaft 311. Additionally, the first piezoelectric element 313 is fixed on the frame housing 301 so that the first piezoelectric element shaft 311 can move in the first direction X. When the first piezoelectric element shaft 311 moves in the first direction X, the first frame 302 also moves in the first direction X relative to the frame housing 301 since the first piezoelectric element shaft 311 is fixed on the first frame 302.

The first piezoelectric element shaft 311 is coupled to the frame housing 301 from the bottom surface thereof and is exposed to the inner part of the frame housing 301. Additionally, a cover plate 316 is attached to the bottom surface of the frame housing 301 so as to protect the first piezoelectric element shaft 311.

A magnetic body 315 and metallic balls 318 at the remaining side of the inner part of the frame housing 301. In the same manner as the first piezoelectric element shaft 311, the magnetic body 315 is coupled to the frame housing 301 from the bottom surface thereof and is exposed to the inner part of the frame housing 301. Additionally, another cover plate 316 is attached to the bottom surface of the frame housing 301 so as to protect the magnetic body 315.

The metallic balls 318 are disposed at both sides of the magnetic body 315. In order to provide a space for moving the metallic balls 318, a sliding groove 317 is formed along the first direction X inside the frame housing 301.

The first frame 302 is contained in the frame housing 301 in such a manner that it can slide in the frame housing 301.

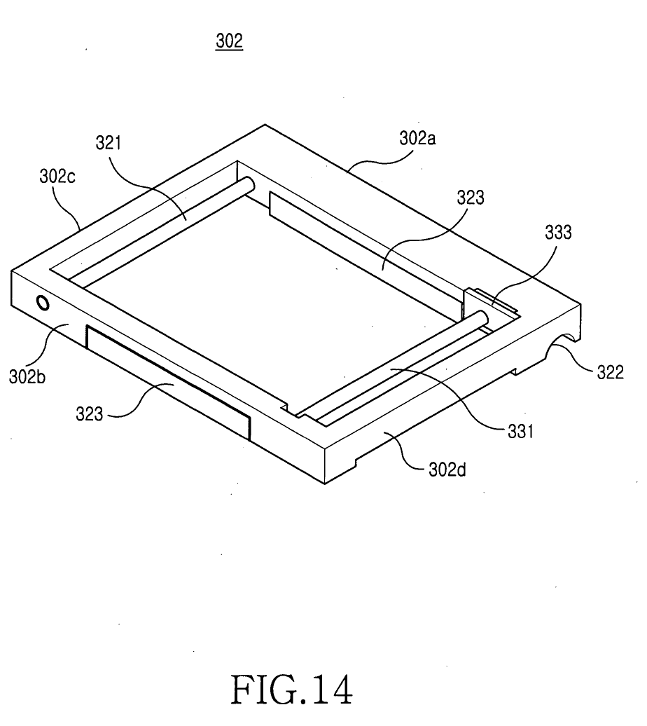

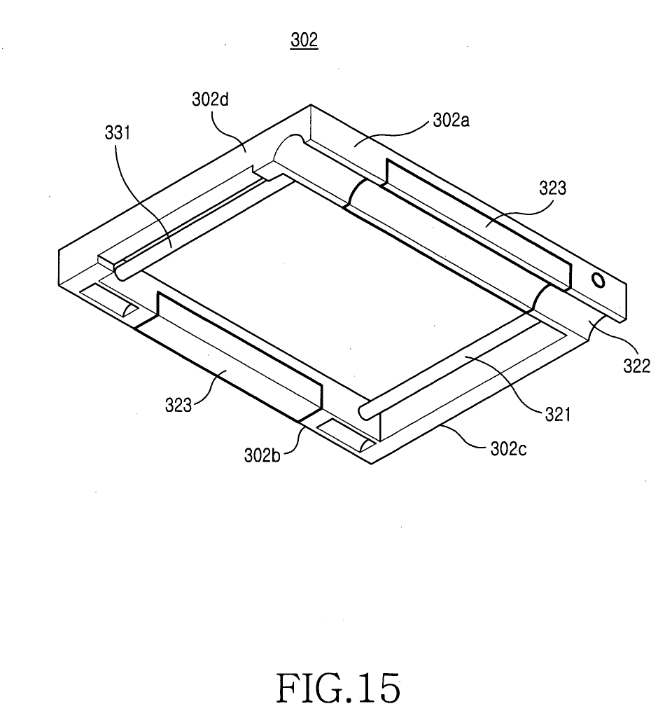

Referring to FIGS. 14 and 15, a first guide groove 329 is formed on the bottom surface of the first lateral end 302a of the first frame 302, the first guide groove having a shape corresponding to the first piezoelectric element shaft 311. A magnetic body 323 is also disposed on the bottom surface of the first lateral end 302a of the first frame 302. The first piezoelectric element shaft 311 is made of a metal susceptible to the attractive force resulting from magnetic forces, and is fixed on the first guide groove 329 by means of the attractive force from the magnetic body 323. Therefore, as the first piezoelectric element shaft 311 moves at high speed or low speed in the first direction X, the first frame 302 moves on the frame housing 301 accordingly.

The attractive force between the first piezoelectric element shaft 311 and the first frame 302 generates a frictional force with a certain strength between the first piezoelectric element shaft 311 and the magnetic body 323. The strength of the frictional force should be greater than the static frictional force between the first piezoelectric element shaft 311 and the magnetic body 323 when the first piezoelectric element shaft 311 moves at low speed, but should be smaller than the inertial force of the first frame 302 when the first piezoelectric element shaft 311 moves at high speed. Therefore, the first piezoelectric element shaft 311 moves along with the first frame 302 when the first piezoelectric element shaft 311 moves at low speed. On the other hand, when the first piezoelectric element shaft 311 vibrates and moves at high speed, only the first piezoelectric element shaft 311 moves while the first frame 302 maintains its static state.

The above-described manner for moving the first piezoelectric element shaft 311 can be controlled according to the strength of magnetic force of the magnetic body 323, and thus can be implemented in a more simple manner than the conventional technique of using springs, etc., for maintaining a constant frictional force.

Another magnetic body 323 is disposed at a second lateral end 302b of the first frame 302 facing to the first lateral end 302a of the first frame 302, the magnetic body 323 facing to the above magnetic body 315 disposed on the frame housing 301. Therefore, the attractive force generating between the magnetic body 323 coupled to the second lateral end 302b of the first frame 302 and the magnetic body 315 disposed on the frame housing 301 restrains the second lateral end 302b of the first frame 302 to be bound on the frame housing 301. Accordingly, assuming that a third direction Z is perpendicular to the first direction X as well as to the second direction Y, the first frame 302 is limited in the movement along the third direction Z according to the above-described structure of the first piezoelectric element shaft 311 and the magnetic bodies 315, 323.

Meanwhile, as the first frame 302 should be capable of moving along the first direction inside the frame housing 301, it is necessary to prevent the first frame 302 from being in close contact with the frame housing 301 due to the attractive force between the magnetic body 315 disposed on the frame housing 301 and the magnetic body 323 disposed on the second lateral end 302b of the first frame 302. In other words, it is necessary to maintain the state in which the frame housing 301 is spaced apart from the first frame 302. This can be accomplished by interposing metallic balls 318 between the frame housing 301 and the first frame 302. Additionally, because the metallic balls 318 are disposed in the sliding groove 317, they facilitate the movement of the first frame 302 in the first direction X.

Although the first frame 302 is prevented from moving along the third direction Z by means of the attractive force between both magnetic bodies 315, 323 disposed on the frame housing 301 and on the first frame 302, the first frame 302 may move in the third direction Z or escape out from the frame housing 301 when the gravity or external impacts are greater than the attractive force between both magnetic bodies 315, 323. In order to prevent the first frame 302 from moving in the third direction Z or from escaping out from the frame housing 301 by a predetermined distance or more, a frame cover 305 is mounted on the lodging surface 319 of the frame housing 301. The frame cover 305 supports edges of one surface of the first frame 302, and thus inhibits the first frame 302 from moving in the third direction Z inside of the frame housing 301.

The second frame 303 is disposed movably in the second direction Y inside the first frame 302. A second guide shaft 321 is fixed at the inner part of a third lateral end 302c of the first frame 302, extending in the second direction Y Additionally, a second guide groove 339 is formed at a first lateral end 303a of the second frame 303, extending in the second direction Y, the second guide groove 339 being engaged slidably with the second guide shaft 321. A third piezoelectric element shaft 331 extending in the second direction Y is fixed and coupled to a second lateral end 303b of the second frame 303, the second lateral end 303b facing to the first lateral end 303a of the second frame 303. The third piezoelectric element shaft 331 is coupled slidably to a fourth lateral end 302d of the first frame 302 at one end thereof, the fourth lateral end 302d facing to the third lateral end 302c of the first frame 302. To the other end of the third piezoelectric element shaft 331, a second piezoelectric element 333 is fixed. Further, the second piezoelectric element 333 is fixed on the first frame 302 so that the third piezoelectric element shaft 331 can move in the second direction Y Accordingly, as the second piezoelectric element 333 drives, the second frame 303 moves in the second direction Y along with the third piezoelectric element shaft 331.

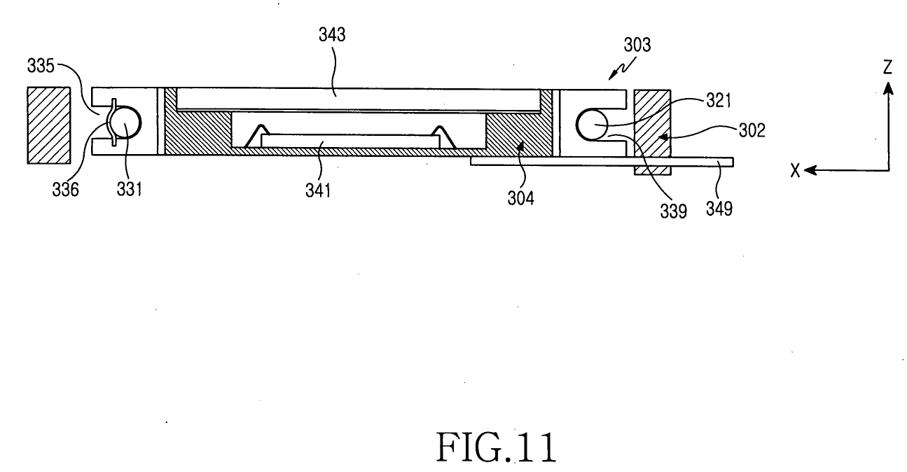

At the second lateral end 303b of the second frame 303, a third guide groove 335 is formed so as to be coupled with the third piezoelectric element shaft 331. The outer circumferential surface of the third piezoelectric element shaft 331 is partially covered with the third guide groove 335. Additionally, a leaf spring 336 (shown in FIG. 11) or the like is coupled to the third guide groove 335 so as to further cover a part of the outer circumferential surface of the third piezoelectric element shaft 331, thereby causing the third piezoelectric element shaft 331 to be closely contacted with the third guide groove 335 under a constant force. Such force provides a constant frictional force between the third piezoelectric element shaft 311 and the third guide groove 335.

Since the first frame 302 moves in the first direction X and the second frame 303 moves in the second direction Y on the first frame 302, the second frame 303 can move each in the first direction X and the second direction Y on the frame housing 301.

The image sensor package 304 is fixed on the first frame 302. As shown in FIG. 11, an image sensor 341 such as a CMOS device or CCD device is disposed inside the image sensor package 304, while an IR cut-off filter 343 is disposed on the outer surface of the image sensor package 304. The image sensor package 304 is connected to circuit devices of a camera or portable terminal main body through a flexible printed circuit 349 or the like.

The optical image stabilizer of the camera lens assembly 300 detects the movement of a camera or portable terminal and drives the first and the second piezoelectric elements 313, 333 according to degrees and rates of the movement in order to correct the position of the image sensor 341. Such operation can be understood easily from the foregoing description regard to the first preferred embodiment.

Meanwhile, although it is not shown, the optical image stabilizer may include a position detector including a light emitting diode and a photo diode in order to detect a change in the position of the image sensor 341. The laser diode for detecting the position of the image sensor 341 is attached to the second frame 303 or the image sensor package 304 and the photo diode is attached to the frame housing 301 so as to detect a relative change in position of the image sensor package 304 to the frame housing 301. Such operation also can be understood easily from the foregoing description regard to the first embodiment.

As described above, according to the optical image stabilizer for a camera lens assembly of the present invention, the driving unit for driving the board, on which an image sensor is mounted, or driving the image sensor package is present substantially on the same surface as the board itself. Therefore, the optical image stabilizer can downsize a camera lens assembly. Additionally, because such downsized camera lens assemblies are mounted on cameras or portable terminals with ease, it is possible to realize various designs of cameras or portable terminals. Further, the camera lens assemblies having such a simple structure can improve the solidity and reliability of products such as cameras or portable terminals.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical image stabilizer for a camera lens assembly, comprising:
a housing;
a board that has an image sensor on a top surface thereof and disposed movably in the housing, the board and the housing being spaced apart from each other;
at least one magnetic body disposed between the board and the housing, the magnetic body providing a magnetic force acting in a direction along which the board is closely contacted to inner surface of the housing;
at least three balls interposed between the board and the inner surface of the housing for maintaining the board in such a state that it is spaced apart from the housing; and
a driving unit for correcting the position of the image sensor by moving the board according to trembling of user's hands.

2. The optical image stabilizer as claimed in claim 1, wherein the board further includes a receipt groove formed on a bottom surface of the board for receiving the balls and the depth of the receipt groove is substantially less than the diameter of the balls.

3. The optical image stabilizer as claimed in claim 1, wherein the magnetic bodies are coupled to each of four corners of the board.

4. The optical image stabilizer as claimed in claim 1, wherein the optical image stabilizer further includes an iron piece attached to the inner surface of the housing, the iron piece interacting with the magnetic force of the magnetic bodies.

5. The optical image stabilizer as claimed in claim 1, further including an IR cut-off filter disposed between an exposure window of the housing and the image sensor, the IR cut-off filter interrupting the IR incident light inputted to the image sensor.

6. The optical image stabilizer as claimed in claim 1, wherein the driving unit includes:
a first driving unit for reciprocating the board linearly in one direction relative to the housing; and
a second driving unit for reciprocating the board linearly in another direction relative to the housing.

7. The optical image stabilizer as claimed in claim 6, wherein the board has a flat planar shape, the first direction extends horizontally to one surface of the board and the second direction extends perpendicularly to the first direction as well as horizontally to one surface of the board.

8. The optical image stabilizer as claimed in claim 6, wherein each of the first and the second driving units includes:
a driving element, which vibrates according to the trembling of user's hands, is attached on the board;
a first support extending from the driving element and reciprocating linearly on the board in the direction horizontal to the board;
a second support disposed on the housing in parallel to the first support;
a first link rotatably coupled to the first support; and
a second link rotatably coupled to the first link at one end thereof and rotatably coupled to the second support at a remaining end thereof.

9. The optical image stabilizer as claimed in claim 6, further including:
an angular velocity sensor disposed on a camera equipped with the camera lens assembly for measuring the change in angular velocity in each of the first direction and the second direction and detecting the trembling of user's hand;
a position detector for detecting a position of the board relative to the housing, the position detector including a photo diode disposed on the housing and a light emitting diode disposed on the board in a position corresponding to the photo diode; and
a controller for operating the driving unit according to the trembling of user's hands detected from the angular velocity sensor and the position of the board relative to the housing detected from the position detector.

10. The optical image stabilizer as claimed in claim 8, wherein the driving element is a ultrasonic motor.

11. The optical image stabilizer as claimed in claim 8, wherein the driving element is a piezoelectric element.

12. The optical image stabilizer as claimed in claim 8, wherein the driving element is a step motor.

13. An optical image stabilizer for a camera lens assembly, including:
a frame housing;
a first frame coupled to the frame housing in such a manner that the first frame can move horizontally along one direction in the frame housing;
a second frame coupled to the first frame in such a manner that the second frame can move horizontally along another direction perpendicular to the first direction on the first frame; and
an image sensor package contained in the second frame.

14. The optical image stabilizer as claimed in claim 13, which further includes:
a first piezoelectric element shaft coupled to a first lateral end of the first frame longitudinally in the first direction, wherein one end of the first piezoelectric element shaft is coupled slidably to the frame housing: and
a first piezoelectric element fixed one end of the first piezoelectric element shaft, the first piezoelectric element being fixed to the frame housing so as to cause the first piezoelectric element shaft to move relative to the frame housing.

15. The optical image stabilizer as claimed in claim 13, which further includes:
magnetic bodies disposed at the first lateral end of the first frame and a second lateral end of the first frame facing to the first lateral end; and
another magnetic body disposed on the frame housing so as to be faced to the magnetic body disposed on the second lateral end of the first frame,
wherein the first frame is restrained in the frame housing by an attractive force generating between the magnetic body disposed on the first lateral end of the first frame and the first piezoelectric element shaft and an attractive force generating between the magnetic body disposed on the second lateral end of the first frame and another magnetic body disposed on the frame housing.

16. The optical image stabilizer as claimed in claim 13, which further includes a frame cover coupled to one surface of the frame housing to prevent the first frame from escaping out from the frame housing.

17. The optical image stabilizer as claimed in claim 13, which further includes a first guide groove formed on a bottom surface of the first lateral end of the first frame and engaged with the first piezoelectric element shaft.

18. The optical image stabilizer as claimed in claim 13, which further includes at least one metallic balls interposed between the frame housing and the first frame to facilitate a horizontal movement of the first frame.

19. The optical image stabilizer as claimed in claim 13, which further includes:
a second guide shaft coupled to inside of a third lateral end of the first frame along the second direction; and
a second guide groove formed on the first lateral end of the second frame to be engaged with the second guide shaft,
wherein the engagement between the second guide shaft and the second guide groove permits the first lateral end of the second frame to slide along the second direction, while inhibiting the first lateral end of the second frame from moving in a third direction perpendicular to the first direction as well as to the second direction.

20. The optical image stabilizer as claimed in claim 13, which further includes:
a third piezoelectric element shaft fixed longitudinally to the second lateral end of the second frame along the second direction, wherein one end of the third piezoelectric element shaft is coupled slidably to a fourth lateral end of the first frame facing to the third lateral end of the first frame; and
a second piezoelectric element fixed to one end of the third piezoelectric element shaft and fixed to the first frame so that the third piezoelectric element shaft can move relative to the first frame.

21. The optical image stabilizer as claimed in claim 13, which further includes:
a third guide groove formed at the second lateral end of the second frame, the third guide groove being engaged with the third piezoelectric element shaft; and
at least one leaf spring coupled to the third guide groove to provide a predetermined frictional force so that the third piezoelectric element shaft can be fixed to the third guide groove.

22. The optical image stabilizer as claimed in claim 13, wherein the image sensor package includes an image sensor embedded therein, and an IR cut-off filter is attached to an outer circumferential surface of the image sensor package.

23. The optical image stabilizer as claimed in claim 13, wherein the first frame, the second frame and the image sensor package are contained in the frame housing and disposed to a height substantially less than the thickness of the frame housing.

24. The optical image stabilizer as claimed in claim 15, wherein the attractive force generating between the magnetic body disposed at the first lateral end of the first frame housing and the first piezoelectric element shaft causes a frictional force maintained between the magnetic body and the first piezoelectric element shaft.
